(19) United States
(12) Patent Application Publication
(10) Pub. No.: US 2016/0066387 A1
(43) Pub. Date: Mar. 3, 2016

(54) COLOR SELECTION

(71) Applicant: LIFI LABS INC, Richmond (AU)

(72) Inventors: Adam Darton, Redwood City, CA (US); Michael Del Borello, Redwood City, CA (US); Benjamin Hamey, Redwood City, CA (US)

(21) Appl. No.: 14/782,866

(22) PCT Filed: Mar. 11, 2014
(86) PCT No.: PCT/AU2014/000235

§ 371 Date: Oct. 7, 2015

Related U.S. Application Data
(60) Provisional application No. 61/804,438, filed on Mar. 22, 2013.

(51) Int. Cl. H05B 33/08

(52) U.S. Cl. CPC H05B 33/0863

(57) ABSTRACT

The present invention provides a processor-based method for selecting a color via an electronic visual display means, the method comprising the steps of: displaying to a user a color spectrum on the electronic visual display means, the color spectrum comprising a first region and a second region; the first region displaying a first user observable color range, the second region displaying a second user observable color range, providing a selection means configured to allow the user to select a color displayed within the second region, wherein the number of user observable colors in the second region is greater than the number of colors observable in the first region. The invention allows for the more precise of color selection for a user, particularly for the color of light emitted by a LED lighting device.

### FIELD OF THE INVENTION

The present invention relates to methods for the selection of a color from a plurality of colors, such as a color spectrum. The color selected may relate to the color of a light, ink, paint, or that shown on an electronic visual display device.

### BACKGROUND TO THE INVENTION

In many scenarios, it is necessary to select a color amongst a very large number of potential colors in a palette. For example, in desktop publishing applications it may be necessary to select a color for text, or a graphical element. Typically, the user is presented with a spectrum of colors from which to select a particular color for use.

As another example, some light emitting diodes (LED) light bulbs allow a user to select certain light colors based on a desired effect, or the user's mood. In particular the designs for RGB, red, green blue LEDs enable color mixing whereby a micro-controller can adjust the intensity, brightness and hue of the individual RGB components to form a color selected by the user via software application running on a personal computing device such as a smart phone, tablet, laptop or desktop.

The vast number of colors discernible by the human eye and the ability of visual display devices to present a staggering number of colors from which a user may select a desired color present problems in color selection by the user. A particular problem is that visual display devices (and especially those on portable devices such as smart phones) lack sufficient area to present all colors to the user.

A further problem is that present color selection means require a user to continuously watch the palette while selecting. This is disadvantageous when selecting the color emitted by an LED globe, for example, as the user much constantly change their field of view between the screen and the room in order to observe the effect of any given color on the ambiance of the room.

It is an aspect of the present invention to overcome or ameliorate a problem of the prior art by providing means for the selection of a color from a very large number of colors on a visual display device.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of this application.

### SUMMARY OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

In one aspect, the present invention provides a processor-based method for selecting a color via an electronic visual display means, the method comprising the steps of:
displaying to a user a color spectrum on the electronic visual display means, the color spectrum comprising a first region and a second region;
   the first region displaying a first user observable color range,
   the second region displaying a second user observable color range,
providing a selection means configured to allow the user to select a color displayed within the second region, wherein the number of user observable colors in the second region is greater than the number of colors observable in the first region.

The present invention expands the concept of a color palette by providing a selection area within a color palette that displays colors available for selection at very high resolution in one area. By this method, the user may select from a vast number of colors (in some embodiments at least 1 million, 2 million, 3 million, 4 million, 5 million, 6 million, 7 million, 8 million. 9 million, 10 million, 11 million, 12 million. 13 million, 14 million, 15 million, 16 million, 17 million, 18 million, 19 million or 20 million discrete color choices from within a spectrum of colors. The regions described herein may be defined by position, dimension, darkening or lightening of the region, and the like. The color range within the second region may be directed by the user, thereby allowing for the user to select from a seemingly infinite color palette. This allows the user to precisely select from far more colors within the color spectrum than a palette having a uniform color resolution across the color range.

In one embodiment, the color spectrum comprises a third region displaying a third user observable color range, the second region disposed between the first region and the third region, wherein the number of user observable colors in the second region is greater than the number of user observable colors in the third region.

In one embodiment, the number of user observable colors in the second region is at least about 5, 10, 20, 30, 40, 50, 60, 70, 80, 90, 100, 200, 300, 400, 500, 600, 700, 800, 900, 1000, 5000, 10000, 20000, 30000, 40000, 50000, 60000, 70000, 80000, 90000, 100000, 200000, 300000, 400000, 500000, 600000, 700000, 800000, 900000, 1000000-fold that in the first region and/or the third region.

In one embodiment, each of the user observable colors in the second region is individually selectable by the user.

In one embodiment, the method comprises providing scrolling means configured to allow the user display a user desired user observable color or color range in the second region.

In one embodiment the electronic visual display means comprises a touch sensitive layer.

In one embodiment, the scrolling means is operable via the touch sensitive layer.

In one embodiment the scrolling means is configured to allow the user to trace a digit across the first region and/or the second region and/or the third region to (i) move a user observable color or color range of the first region into the second region or (ii) bring a user observable color or color range of the third region into the second region.

In one embodiment the method comprises providing a haptic feedback mechanism configured to allow the user to select a color without the need to view the electronic visual display means for the entire duration of the method.

In one embodiment, selecting the color is for the purpose of selecting a color emitted by a light emitting diode or a group of light emitting diodes.

In one embodiment, selecting the color is for the purpose of selecting a color within a computer application.

In one embodiment, the computer application is a graphics application, a drawing application, a desk top publishing application, a word processing application, or a photograph processing application.

In another aspect, the present invention provides a processor-based device for selecting a color, the device comprising
an electronic visual display means for displaying a color spectrum to a user, the color spectrum comprising a first region and a second region,
   the first region displaying a first user observable color range,
   the second region displaying a second user observable color range,
a selection means configured to allow the user to select a color displayed within the second region,

wherein the number of user observable colors in the second region is greater than the number of user observable colors in the first region.

In one embodiment, the color spectrum comprises a third region displaying a third user observable color range, the second region disposed between the first region and the third region, wherein the number of user observable colors in the second region is greater than the number of user observable colors in the third region.

In one embodiment, the number of user observable colors in the second region is at least about 5, 10, 20, 30, 40, 50, 60, 70, 80, 90, 100, 200, 300, 400, 500, 600, 700, 800, 900, 1000, 5000, 10000, 20000, 30000, 40000, 50000, 60000, 70000, 80000, 90000, 100000, 200000, 300000, 400000, 500000, 600000, 700000, 800000, 900000, 1000000-fold that in the first region and/or the third region.

In one embodiment, each of the user observable colors in the second region is individually selectable by the user.

In one embodiment, the device comprises scrolling means configured to allow the user display a user desired user observable color or color range in the second region.

In one embodiment, the electronic visual display means comprises a touch sensitive layer.

In one embodiment, the scrolling means is operable via the touch sensitive layer.

In one embodiment, the scrolling means is configured to allow the user to trace a digit across the first region and/or the second region and/or the third region to (i) move a user observable color or color range of the first region into the second region or (ii) bring a user observable color or color range of the third region into the second region.

In one embodiment, the device comprises a haptic feedback mechanism configured to allow the user to select a color without the need to view the electronic visual display means for the entire duration of the method.

In one embodiment, selecting the color is for the purpose of selecting a color emitted by a light emitting diode or a group of light emitting diodes.

In one embodiment, selecting the color is for the purpose of selecting a color within a computer application.

In one embodiment, the computer application is a graphics application, a drawing application, a desk top publishing application, a word processing application, or a photograph processing application.

In one embodiment, the device is a smartphone or a tablet computer.

In a further aspect the present invention provides a software application configured to execute a method as described herein.

In one embodiment, the software application is configured to be executable on a device as described herein, including devices reliant on an operating system selected from iOS, OS X, Android, Blackberry, Nokia OS, Windows, Windows mobile, Windows phone, Linux, Mobile Linux, and HTC Sense.

In a further aspect, the present invention provides a method for selection of a color by a user, the method comprising the steps of providing a device as described herein, and allowing a user to select a color.

In one embodiment, the device comprises a software application as described herein

Yet a further aspect of the present invention provides a lighting system comprising a device as described herein, and a LED lighting device configured to emit a plurality of colors, wherein the LED lighting device is configured to emit a light having a color substantially the color selected by a user on the device. The

In one embodiment, the LED lighting device comprises three individual diodes, the first diode capable of emitting red light, the second diode capable of emitting green light, the third diode capable of emitting blue light. An optional fourth diode may be provided in one embodiment which is capable of emitting white light. These systems are known as “RGB” and “RGBW” refers to a lighting system reliant on a combination of red, green and blue, or red, green, blue and white LEDs to form a multi-capable lighting device that can mix varying intensity of hue and power of each color to form almost all colors within the visible light spectrum.

This invention applies a processor-based method for selecting color via an electronic visual display that enables a broadening of the color choices the user can select, and in some embodiments a software application sends to microprocessors capable of receiving, parsing and displaying colors generated by hexadecimal color codes, and rendering those colors by mixing various intensities and hues of RGB and RGBW lighting arrangements.

In one embodiment, the LED lighting device and the device for selecting a color are operably connected by way of radio communication. The means of radio communication may be by any analog or digital means, but will typically be by WiFi protocol. In such embodiments the LED light comprises a WiFi module, or WiFi micro-controller: A WiFi module, or micro-controller is a specific wireless radio chipset operating on a 802.11 or 802.15.4 range capable of sending and receiving messages from other computing devices, micro-controllers or networks and parsing that data for use by the device in which the chip resides. In one embodiment the WiFi module is the wireless component that works together with the micro-processor to receive commands from a user via the device described herein, that forming the basis for receiving messages, commands and data from the application

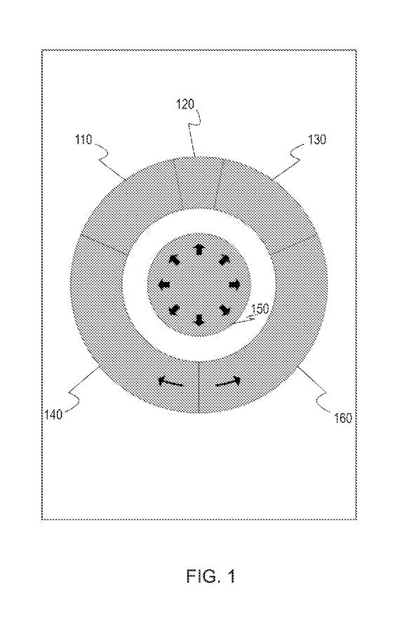

Reference is now made to FIG. 1. which shows a representation of a smartphone user interface and method of control designed to allow users to expand their ability to select colors from within the a visible color palette that can be rotated either clock-wise or counter clockwise to reveal more color options; then create further options by adjusting the brightness, hue, or intensity of any of the colors within the visible palette.

In the control of lighting for RGBW (red, green, blue, white) light emitting diodes, the method and means for selecting colors via a user interface is important but selecting from within a finite color palette creates limitations in the user's ability to have fine control of the exact colors they wish to create.

The present invention will now be more fully described by reference to the following non-limiting preferred embodiments, and in which:

FIG. 1 is a diagram of a smart phone graphical user interface of a preferred embodiment.

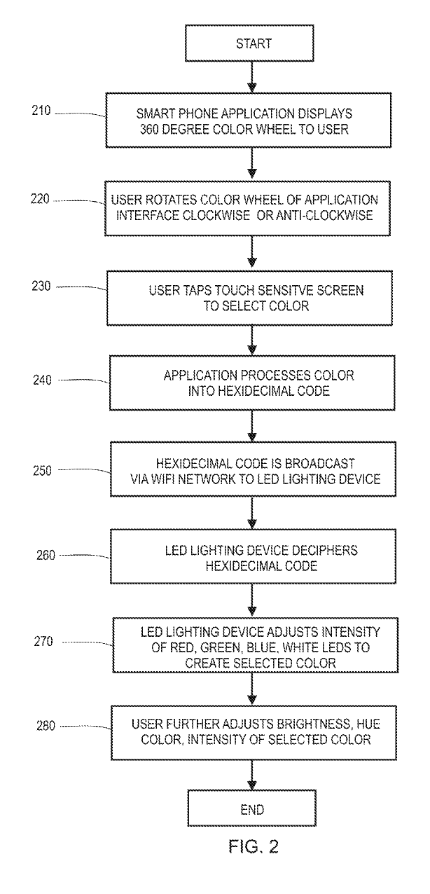

FIG. 2 is a flow diagram showing the preferred steps in setting an modifying a lighting condition of a LED lighting device.

### DETAILED DESCRIPTION OF PREFERRED EMBODIMENTS

Hereinafter, preferred embodiments of the present invention will be described in detail with reference to the accompanying drawings. Here, it is to be noted that the present invention is not limited thereto. Furthermore, the step serial numbers concerning the color control method are not intended thereto limit the operating sequence and any rearrangement of the operating sequence for achieving same functionality is still within the spirit and scope of the invention.

Reference is made to FIG. 1, being a diagram of a user interface suitable for executing a method of the invention. The user interface is for selecting a color via a smartphone visual display. Color is selected and controlled by the user via a touch screen that enables the user to scroll within an observable color spectrum 110, 120, 130. The second region 120 displays a portion of the colour spectrum in high resolution, while the first region 110 displays colors of a lower wavelength than those in the second region, and the third region 130 displays colors of a higher wavelength. Thus, at a glance the user can determine roughly within which part of the spectrum they are selecting colors (ie. those colors in the second region 120), and also which direction the display should be swiped in order to move a different colour region into the second region 120.

The palette can be affected by three principal means (1) rotation of the wheel to provide a widening of the color palette available to the user for selection within a specific color, or any specific color (2) the ability to lighten or darken any of the colors from within the infinite color palette by controlling the lightening or darkening of the visible color spectrum via touch control (3) the saving of any of the individual colors chosen from within the infinite palette to a defined palette of colors that the user can add to, delete, repeat or reselect from the swatch. (4) the haptic feedback response from the device to the user when the user chooses the final realising value on the color selection palette or more specifically when they reach the theoretical limit for the selected value, e.g. the whitest color selectable on the palette when reached will provide haptic feedback to the user so they can feel, or be informed by the sense of feel that the limit has been reached. Haptic feedback is used in this preferred embodiment such that the user is not forced to watch the color spectrum constantly. As used herein, the term haptic feedback includes any technology which takes advantage of the sense of touch by applying forces, vibrations, heat, or motion to the user that may incorporate tactile sensors that measure forces exerted by the user on the interface.

For clarification of terms, the defined palette is a finite palette of colors the user has created, selected, and saved for repetition or re-use at a later point in time.

Lightening and darkening in this case means adding and reducing the white balance to the selected color to create further colors from which a user can select.

Once the user selects a color in the second region, that color is relayed as a hexadecimal code to a LED lighting device. This process is shown in greater detail in FIG. 2.

The microprocessor of the LED lighting device incorporates the functions of a computer's central processing unit (CPU) on a single integrated circuit (IC), or at most a few integrated circuits. It is a multipurpose, programmable device that accepts digital data as input, processes it according to instructions stored in its memory, and provides results as output. It is an example of sequential digital logic, as it has internal memory.

The four regions of the interface that form the means of control for achieving the aforementioned commands are the basis for a preferred embodiment of the invention and are shown as 110, 120, 130, 140, 150, and 160.

The method by which the user selects and shifts through the available colors is via an electronic visual display. The user selects a desired color from the second region 120 displaying colors at higher resolution, as compared with the first region 110 and second region 130. The higher resolution of colors displayed in the first region 120 allowing for the display and selection of colors from a more narrow color range (or even a single color) thereby allowing the user more precise color selection. The selection of color is via a tapping of the screen at the second region 120, or other gesture in relation to the second region.

A rotational interface for modifying the color or color range displayed within the second region 120 is provided. For example, where the second region 120 displays a range of blues at high resolution, the rotational interface may be actuated by the user such the second region 120 now displays a range of reds at high resolution (the blues being rotated out of region 120 and into region 110 or 130 and now shown at low resolution).

It will be seen that a range of selectable colours in a spectrum dynamically expands when rotated into the region 120 to provide more colors for visualization by the user and also selection by the user, thereby increasing the user's ability to choose a particularly desired color.

The ability of the user to visualize colors outside of the high resolution visualization and selection region 120 facilitates user selection of a new color. For example, where the region 120 displays greens, the region 110 may display colors of a shorter wavelength (such as blues), while region 130 displays longer wavelength colours (such as reds). Thus, where the user wishes to select a red, the interface is rotated in the required direction (anti-clockwise) to rotate reds into the region 120. By contrast, where a blue is desired the interface is rotated clockwise. Thus, the user can immediately note which direction the interface is to be rotated in order to select a desired color.

Rotation of the color wheel interface shown in FIG. 1 can be achieved by tapping or swiping the region 140 (to cause clockwise rotation) or 160 (to cause anti-clockwise rotation). The regions 140 and 160 may be non-colored and have arrow indicia (as shown) indicating the direction. Alternatively, the regions 140 and 160 may display part of the colour spectrum in low resolution in which case they are essentially continuous with regions 110 and 130 respectively.

The interface may auto-rotate such that a user could simply tap a blue region on the first or second region and the color wheel may rotate such that a high resolution blue portion of the color spectrum is displayed in the second region.

The interface may comprise a modifier region 150 to allow (with tapping, swiping or other gesture) modification of one or more parameters of the selected color. The region 150 may be used to modulate brightness, darkness, saturation or hue to the selected color depending on the varying degrees of intensity controlled by the user. The region 150 may be considered as a virtual track ball allowing the modification of one or more parameters by the user's finger “rolling” the track ball in any direction as shown by the arrowed indicia.

Haptic feedback may be given to user when the theoretical limit of a parameter is reached, e.g. the brightness is set to full intensity. The device (such as a smart phone) may emit when a limit is reached.

The interface of FIG. 1 is a graphical user interface allowing the user to control any mobile device including but not limited to a smart phone, a tablet, a laptop, a netbook, a smart watch, Google™ glass. The device may be a fixed device such as a desktop computer is capable of rendering the described invention on its display and can receive commands via touch, haptic feedback, motion, gesture or movement of a further input device including but not limited to a mouse or touch screen of any kind, from the user.

This color control method described is for the purposes of relaying the color hexadecimal code via a wireless network to a device that receives commands from the network, processes via a microcontroller or other computation device and displays the selected color as a colored light/s that matches the selection made by the user on their electronic display by mixing red, green, blue and white values to form an RGBW to for the perceived color match between selection and light seen by the user a process that is described herein and diagrammed in FIG. 2.

The application displays a 360 degree, rotatable color wheel to the user for color selection in the region 120 of FIG. 1 210. The interface displaying a color wheel with a palette of colors to the user the interface providing a touch sensitive layer whereby the user can rotate the color wheel to reveal more colors from the color spectrum and increase the available palette of colors for selection 220, 230 The application uses the color selected by the user and matching the hexadecimal code that creates the color on the interface into a command that the application the application then 240 wirelessly transferring to the WiFi receiver and then 250 sending the message to the micro-processor within the bulb that houses the RGB-W LEDs, receives the signal and then 260 mixing the LEDs so as to render the color visible to the user as a similar, if not identical color of light to the selection. 270 the user can use any aspect described in FIG. 1 to alter the intensity or brightness of the selected value 280 thereby controlling the visible light emitted by the LED lighting device.

It should be appreciated that in the above description of exemplary embodiments of the invention, various features of the invention are sometimes grouped together in a single embodiment, figure, or description thereof, for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention.

1-20. (canceled)

21. A method for enabling a user to select a color appearance via an electronic visual display, the method comprising:
displaying a hue spectrum on the electronic visual display; wherein the hue spectrum comprises an ordered set of adjacent selectable hues; wherein the hue spectrum is divided at a first hue and a second hue into a first region, a second region, and a third region; wherein the second region is bounded by the first hue and the second hue and is disposed between the first region and the third region; wherein the hue spectrum is displayed in the shape of a partial annulus; wherein each selectable hue is displayed as a sector of the partial annulus;
displaying in the first region a first subset of the ordered set of adjacent selectable hues with a first physical space occupied by each hue in the first subset;
displaying in the second region a second subset of the ordered set of adjacent selectable hues with a second physical space occupied by each hue in the second subset, wherein the second physical space occupied by hues in the second subset is larger than the first physical space occupied by hues in the first subset;
displaying in the third region a third subset of the ordered set of adjacent selectable hues with a third physical space occupied by each hue in the third subset, wherein the third physical space occupied by hues in the third subset is larger than the first physical space occupied by hues in the first subset;
detecting a touch event at a touch sensitive layer of the electronic visual display; wherein the touch event comprises a position selection;
adjusting the subset of hues displayed in the second region based on the position selection; wherein adjusting the subset of hues comprises selecting a selected hue from the subset of hues displayed in the second region; and
emitting light of the selected hue from a light emitting diode based on the hue selection.

22. The method of claim 21, further comprising detecting a time sequence of touch events comprising a scrolling event; wherein adjusting the subset of hues displayed in the second region is performed based on the scrolling event; and further comprising selecting a selected hue from the subset of hues displayed in the second region based on a last touch event in the time sequence of touch events.

23. The method of claim 21, wherein the light emitting diode has an adjustable brightness level, further comprising receiving a brightness selection and adjusting the adjustable brightness level based on the brightness level selection.

24. A method for enabling a user to select a color appearance via an electronic visual display, the method comprising:
displaying a hue spectrum on the electronic visual display, the hue spectrum comprising an ordered set of adjacent selectable hues divided at a first hue into a first region and a second region;
displaying, in the first region, a first subset of adjacent selectable hues with a first physical space occupied by each hue in the first subset;
displaying, in the second region, a second subset of selectable hues with a second physical space occupied by each hue in the second subset, wherein the second physical space occupied by hues in the second subset is larger than the first physical space occupied by hues in the first subset;
receiving a position selection;
adjusting the first hue at which the hue spectrum is divided based on the position selection; and
receiving a hue selection comprising a selected hue, wherein the selected hue is displayed along the hue spectrum.

25. The method of claim 24, further comprising emitting light of the selected hue from a light emitting diode based on the hue selection.

26. The method of claim 25, further comprising receiving an operating characteristic selection, and adjusting an operating characteristic of the light emitting diode based on the operating characteristic selection.

27. The method of claim 26, wherein the light emitting diode has an adjustable brightness level, wherein the operating characteristic selection comprises a brightness value, and wherein adjusting the operating characteristic of the light emitting diode comprises adjusting the brightness level of the light emitting diode based on the brightness value.

28. The method of claim 27, wherein the light emitting diode is operable between an on-state and an off-state; wherein the operating characteristic selection comprises a power state, and the power state is either the off-state or the on-state;
and operating the light emitting diode in the power state.

29. The method of claim 24, wherein the second region of the hue spectrum is divided at a second hue to form a third region; wherein the second region is disposed between the first region and the third region; further comprising displaying in the third region a third subset of selectable hues with a third physical space occupied by each hue in the third subset; and wherein the second physical space occupied by hues in the second subset is larger than the third physical space occupied by hues in the third subset.

29. The method of claim 29, wherein the first, second, and third regions are displayed in the shape of a partial annulus; wherein a last hue in the third subset of adjacent hues is an initial hue of the first subset of adjacent hues; wherein each hue is displayed as a sector of the partial annulus.

31. The method of claim 29, further comprising adding hues to the subset of hues displayed in the second region of the hue spectrum, based on the position selection.

32. The method of claim 31, wherein hues added to the subset of hues displayed in the second region are removed from the subsets of hues displayed in the first and third regions.

33. The method of claim 24, further comprising receiving a saturation level selection comprising a saturation value.

34. The method of claim 24, further comprising receiving a lightness level selection comprising a lightness value.

35. The method of claim 24, wherein the hue spectrum spans all visible hues.

36. The method of claim 24, further comprising communicating haptic feedback at the electronic visual display to signify a successful receipt of the hue selection.

37. The method of claim 24, wherein receiving the hue selection comprises detecting a touch event initiated by the user at a touch sensitive layer of the electronic visual display; wherein the touch event is detected at a region of the hue spectrum where the selected hue is displayed.

38. The method of claim 37, wherein a sequence of touch events is detected as a scrolling motion; wherein the subsets of hues in the first, second, and third regions are adjusted based on the scrolling motion.

39. The method of claim 24, further comprising displaying a hue spectrum overlaid with a saturation gradient; wherein the hue spectrum transitions between hues in a first direction; wherein the saturation gradient is along a second direction and the first direction is at an angle relative to the second direction.

40. The method of claim 24, wherein the position selection comprises the hue selection.
